(19) United States
(12) Patent Application Publication
(10) Pub. No.: US 2007/0295869 A1
(43) Pub. Date: Dec. 27, 2007

(54) Portable support kit for positioning items over bedding

(75) Inventors: John G. Noelke, Ft. Pierce, FL (US); James Sowinski, Vero Beach, FL (US)

Correspondence Address: MCHALE & SLAVIN, P.A., 2855 PGA BLVD, PALM BEACH GARDENS, FL, 33410, US

(73) Assignee: Sonotech, LLC

(21) Appl. No.: 11/472,961

(22) Filed: Jun. 21, 2006

(51) Int. Cl. F16M 11/00

(52) U.S. Cl. 248/125.1

(57) ABSTRACT

A support kit for use in support of tubular items placed over a bed. The support kit is designed to be portable and deployed on any standard bed. The support has a bi-pod base placed between the mattress and the inner spring of the bed. An upright post, removably attached to the base and adjustable in height, and employs coupling joints to allow for storage folding, the post is used to carry hose clamps. A bracket attached to the top of the pole has a cantilever arm pivotally attached by an adjustable spring loaded pulley. The cantilever arm also carries hose clamps. The support kit allows for the placement of tubular items, such as an air hose, at a distance from the bed and above the head of the user allowing the hose to descend vertically to the user. The cantilever arm pivots to compensate for the movement of the tubing and the spring loaded pulley absorbs the shock to the line. The adjustable spring compensates for different weighted tubes or when multiple tubes are carried.

### FIELD OF THE INVENTION

This invention relates to the field of support appliances and, more particularly, to apparatus used to support tubular items over bedding to aid in the comfort of individual having sleep apnea or other breathing disorders that require the delivery of air or oxygen.

### DESCRIPTION OF THE PRIOR ART

There are numerous items that can be positioned over a individual laying in a bed. One of the most common items is the use of a breathing tube feeding a mask worn by individuals suffering from sleep apnea. While this invention is not limited to the holding of breathing tubes, an example directed to sleep apnea best illustrates how the comfort of the individual is paramount especially when an individual is confined to a bed for any length of time.

Sleep apnea affects a large majority of the population and can lead to health problems stemming from a lack sleep and/or oxygen deprivation. A common treatment method is the use of a breathing mask worn by the individual which is fed by a positive pressure of air and/or oxygen. Individuals suffering from sleep apnea, as well as other breathing disorders, rely upon the use of a positive pressure respirator which includes a facial mask fed by a tubular breathing line. The breathing tube creates a large discomfort to the individual by adding weight to the mask as well as restricting movement when the breathing tube is dragged across bedding.

The use of positive pressure respirators to treat sleep apnea is known, as taught by Hansen et al, U.S. Pat. No. 6,516,802, which discloses a device to control a hose in a CPAP continuous positive airway pressure, system.

The problem of maintaining an open breathing tube and minimizing the stress on the mask and the wearer's head has been addressed in other prior art patents, for example, Koncsek, U.S. Pat. No. 5,836,361, Harmon, U.S. Pat. No. 5,279,486, and Dvorachek, U.S. Pat. No. 4,238,096 with varying degrees of success.

A product on the market is the, “EZZZ SWING,” Bedside Awing Arm, Part No. QA01, Quality of Life, Inc. of Minnetrista, Minn., which has a post mounted on a bed and a gooseneck near the top with a Velcro tab to secure the air hose.

The problem with the prior art support systems is the complexity and associated high manufacturing cost which makes them unaffordable for the general public. The Applicants developed a Comfort Enhancer For A Breathing Apparatus, U.S. Pat. No. 7,040,581 which is directed to a supporting device, the contents of which is incorporated herein by reference. While the Comfort Enhancer addresses a number of the current needs regarding complexity of design, it fails to address the ability to adjust for various weights associated with the breathing tube and foldability for very compact storage.

U.S. Pat. No. 6,019,484 discloses a support assembly for use in holding of a light. The support assembly includes the use of a telescoping mast for support of a boom arm.

U.S. Pat. No. 2,997,242 discloses a support assembly for a therapeutic fog generator. The support assembly includes a spring biased cantilevered arm for support of the delivery device near the individual face while laying in a bed.

Thus, what is needed in the art is a low cost, simple support system that can be easily assembled and disassembled for travel and provides a variable position for the mask without becoming entangled with the user or the bedding.

### SUMMARY OF THE PRESENT INVENTION

Disclosed is a support kit having a unique use for tubular items such as breathing hose for positioning over a bed. The support kit includes a base that is placed beneath a bed which supports a post having a top end, a bottom end and being adjustable in length. A pair of hose claims are slidably affixed to the post adapted to engage tubular pipe such as a breathing hose. A bracket is adapted to be connected to the top end of the post and includes a pulley mounted to rotate in a plane parallel with the post. The pulley has a circumferential groove with a spring attached at one end to the bracket and disposed in the groove. The other end of the spring is attached to the pulley whereby rotation of the pulley lengthens the coil spring and applies a spring bias to the pulley. A fastener on the periphery of the pulley is used for securing a cantilever arm adapted to extend from the fastener normal to the post. A second pair of hose clamps are adapted to be adjustably affixed to the cantilever arm whereby the kit allows for positioning of the tubular pipe over the bed which eliminates the stress placed on the mask worn by the individual.

An objective of this invention is to provide a system for treating sleep apnea that removes the breathing hose from contact with the user and the bed while providing a variable position for the hose to compensate for movement of the user.

It is another objective of this invention to provide a support post and cantilever arm coupled by a spring biased pulley to control the position of the hose.

Another objective of the invention is provide a spring tension adjustment link to the spring biased pulley, the adjustable spring allows for various weighted tubing, wear, as well as the use of multiple tubing or carrying of unusually heavy items.

It is a further objective of this invention to provide the components with structure permitting manual assembly and disassembly without the use of tools. The components are also formed to be reduced in size for ease of packing.

Still another objective of the invention is teach the use of a collapsible post that can employ a shock cord to allow for no-instruction, quick assembly. Alternatively, the collapsible post may be threaded to allow ease of assembly yet provide a compact kit upon disassembly.

Still another objective of the invention is teach the use of two additional apertures drilled parallel to the support post aperture. These apertures intersect base leg passageways for storage of one piece base legs utilizing the same thumb screws used for holding of the support.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### SHORT DESCRIPTION OF THE DRAWINGS

FIG. 1 is a side view of the assembled support of this invention without the air hose;

FIG. 1A is an enlarged detail view of the support post mount;

FIG. 2 front view of the support of this invention;

FIG. 3 is a back view of the support of this invention;

FIG. 4 is a top view of the base of the support of this invention;

FIG. 5 is a side view of the base with a leg of this invention;

FIG. 6 is a top view of a hose clamp of this invention;

FIG. 7 is a top view of a storage stay of this invention; and

FIG. 8 is a top view of an alternative storage stay of this invention.

### DETAILED DESCRIPTION OF THE INVENTION

For purposes of illustration, reference will be made to the use of a CPAP machine to illustrate the support functions and operation of the instant invention. A CPAP machine is normally placed near the user's bed and a length of breathing hose extends from the machine to a mask worn by the user while asleep. The breathing hose has sufficient length to allow for movement of the wearer during the night however, the hose has a tendency to become entangled in the bedclothes and wrap around the wearer.

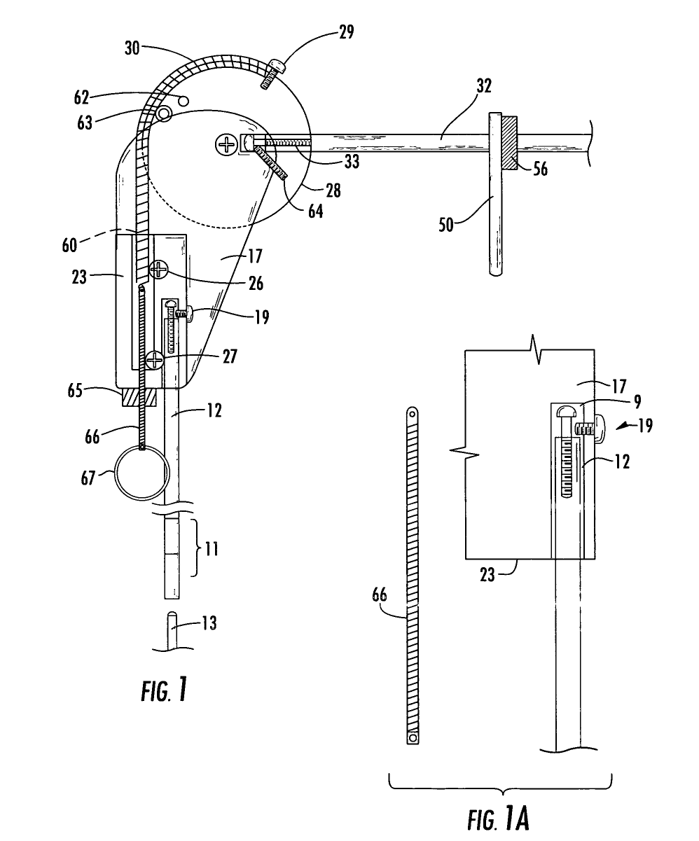

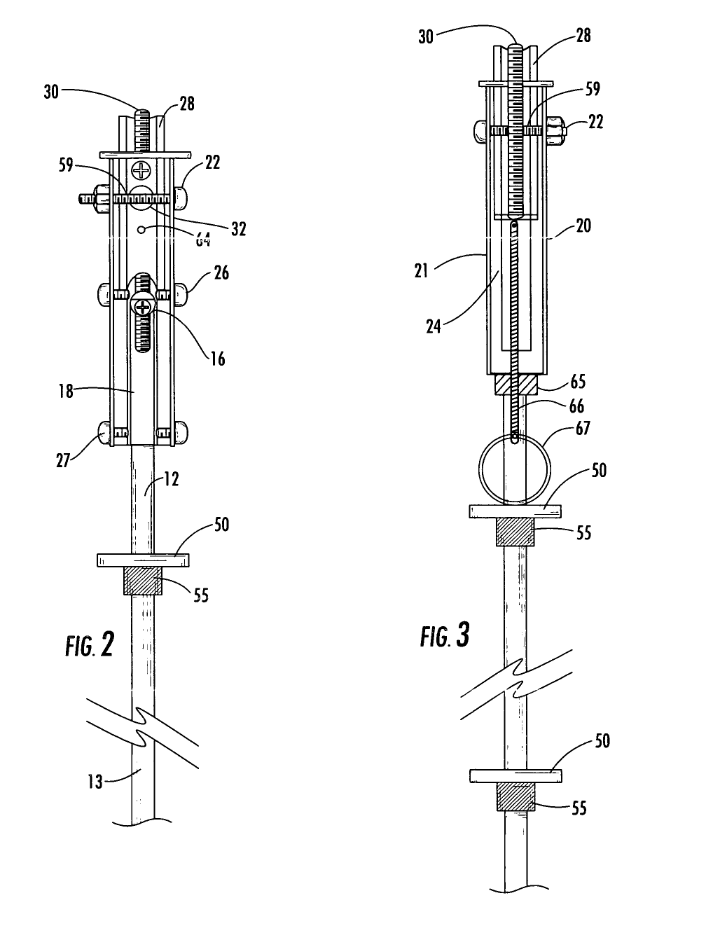

The support device 10, referring to FIGS. 1-3, provides flexible support for items placed over bedding, such as the breathing hose of a CPAP machine (not shown). A support post 11 is spaced laterally from a bed (not shown) and extends perpendicularly above the bed to a height to clear the normal turning of a sleeping wearer. The support post may be in separate sections 12 and 13, as shown, with male and female fittings, telescoping tube, threaded, or hinged. Additional sections 13 may be added if additional height is required. A pair of hose clamps 50 are slidably mounted on the support post, hose clamp collars 56 are frictionally mounted on the support post. The position of the hose clamp 50 may be adjusted by moving the hose clamp collar 56 to the desired location. The top end 16 of the post is connected to a bracket 17 by inserting the end into a bore 18. The end 16 is secured to the bracket by a set screw 19 threaded through the wall of the cavity and contacting the end of the post.

The bracket 17 is composed of two parallel planar sides 20 and 21 connected by an axle 22 and a rectangular insert 23. The edge 24 of the insert has a threaded hole for the set screw 19 and an aperture for passing of the spring tension adjustment link 66. The sides of the insert are attached to the bracket by screws 26 and 27. The bottom end of the insert has a bore 18 for insertion of the support post 11. FIG. 1A provides an enlarged detail of the support post wherein set screw 19 prevents post 12 from detaching from the bracket assembly 17. Set screw 19 does not make contact with post 12 but rather fits between the post and end mounted bolt 9 being positioned directly beneath the head of the mounted bolt 9. This allows the bracket assembly 17 to swivel on the support post 12 mounting bolt 8 while the set screw 19 prevents unwanted to disengagement.

A pulley 28 with bushing 59 is rotatably mounted on the axle 22 with a spring retainer fixed to the circumference of the pulley by retainer screw 29. A coil spring 30 extends from the spring retainer screw 29 on the bracket to the spring tension adjustment link 66. A ring 67 is secured to the free end of the adjustment link 66 which allows insertion of a human finger index for applying a downward pressure. Adjustment nut 65 is knurled and can be turned by hand when said pressure is applied to said ring 67. The coil spring 30 maintains a spring bias on the rotation of the pulley 28 to return to its original position after rotation, the spring tension adjustment link 66 permits adjustment for worn springs, heavy loads, and the like. The pulley 28 has a machine screw pin stop 63 on each side of the pulley 28 to engage the bracket 17 in the original position and limit spring biased return rotation. The screw pin stop 63 may be relocated to stop pin hole 62 allowing for the raising of the cantilever arm. The spring bias may be generated by other types of springs acting between the pulley and the bracket. The spring tension generated by the rotation of the pulley need not be high but enough to prevent slack in the breathing tube.

A cantilever arm 32 is attached at one end 33 about the circumference of the pulley 28 to extend generally normal to the support post 11 and parallel to the bed above the user. The cantilever arm 32 is maintained in position by an allen set screw 64. A pair of hose clamps 50 and hose clamp supports 56 are slidably connected to the arm to initially adjust the hose toward the vertical between the mask and the hose clamps. In this manner, the weight of the hose is compensated for by the spring bias on the pulley which is transferred to the cantilever arm 32. Alternatively, the placement of the hose at the end of the cantilever arm 32 can have the weight compensated by movement of the spring tension adjustment link 66 which is locked into position by adjustment nut 65. The arm may be one piece, hinged, telescoping tubes, or sections connected by male, female joints.

When the wearer rolls or moves his head away from the post 11, the cantilever arm 32 will move vertically downwardly and, if necessary, the bracket 17 will rotate on the support post 11 to relieve tension on the hose. As the wearer moves back toward the post, the arm will move upwardly in response to the spring bias to remove slack from the hose.

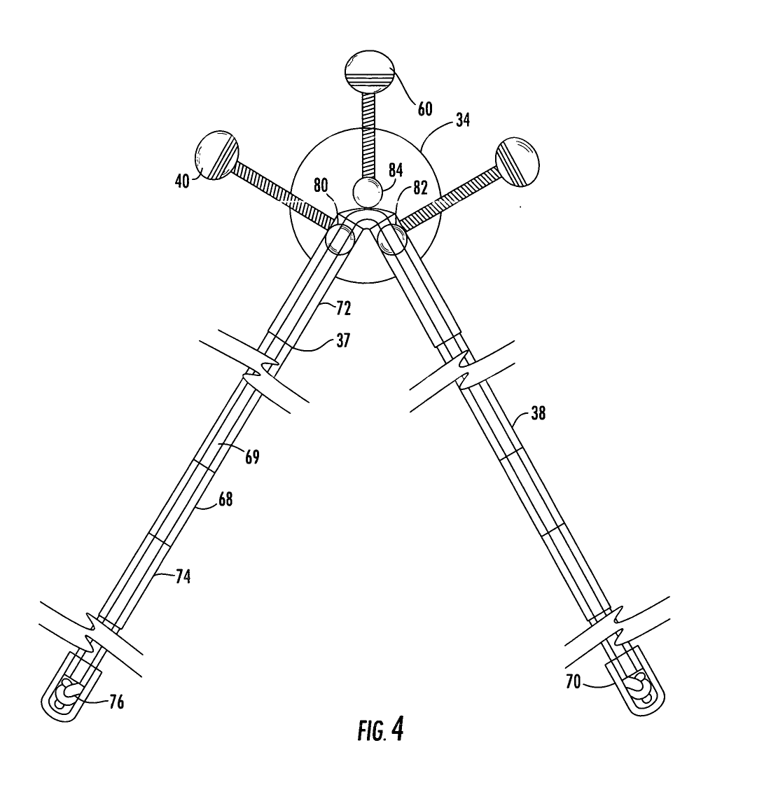

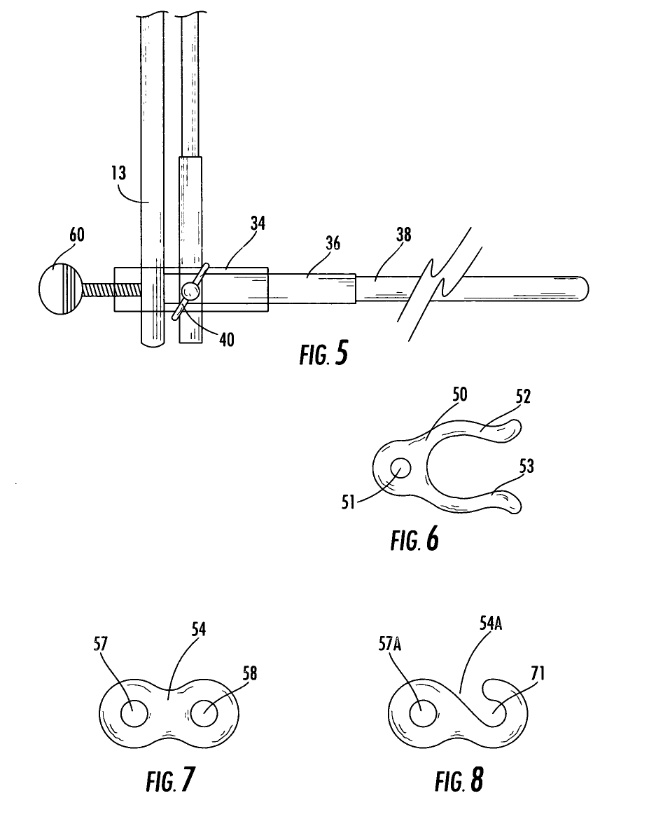

The support device 10 has a base 34, shown in FIG. 4, that is preferably placed between the mattress and the springs of the bed but may sit on the floor or a table with appropriate weighting or anchoring. The base has an aperture 35 and is slidable along the support post 11. The base 34 has a thumbscrew 40 threaded into the aperture 35 to secure the base to the post at the proper height. The base 34 is a bi-pod fixture with a V-shaped passageway to receive two base legs 37 and 38. Each passageway has a thumbscrew 40 to secure the legs to the base. The legs may be one piece, or telescoping tubes, or hinged, or sections connected by male female joints. A hinged joint is shown wherein the leg 37 is hollow with an elastic shock cord 69 extending therethrough. In this embodiment, a connector tube 68 allows for the securement of an upper leg 72 to a lower leg 74. A protective cap 70 may be placed over the end of the leg to conceal the elastic shock cord attachment knot 76. Cross drilled holes 80 and 82 are used for base rod storage when the full-length one-piece base rods are used.

The hose clamps 50 have an aperture 51 in one end for insertion of the support post 11 or the cantilever arm 32. The other end of the clamp is formed with two resilient arms 52 and 53 for frictionally holding the breathing tube. The open arms allow the hose to separate from the clamps in the event of a sudden and/or forceful pull on the hose.

The support appliance is designed to be collapsible for ease in traveling and storage. The components may be assembled and disassembled by hand. Several storage stays 54 can be included. The stays have an elongated flat body with apertures 57 and 58 in each end. One stay is slidably mounted on support post 12 by aperture 57. The disassembled support post and cantilever arm may be linked together by inserting the cantilever arm in the aperture 58 of the stay to minimize space requirements. An alternative storage stay 54A is depicted with having an elongated flat body with an aperture 57A located along one end and an open stay hook 71 located at the opposite end.

A number of embodiments of the present invention have been described. Nevertheless, it will be understood that various modifications may be made without departing from the spirit and scope of the invention. Accordingly, it is to be understood that the invention is not to be limited by the specific illustrated embodiment but only by the scope of the appended claims.

What is claimed is:

1. A support kit for a tubular hoses comprising a base member having a plate adapted to be disposed beneath a mattress, a bi-pod fixture mounted on said plate with at least two legs adapted to connected thereto; a post having a bottom end adapted to be removably attached to said base normal to said bed, a top end spaced apart from said bottom end by at least one coupling joint; at least one first hose clamp slidably affixed to said post adapted to engage a tubular hose; a bracket adapted to be connected to said top end of said post, said bracket including a pulley mounted to rotate in a plane parallel with said post, said pulley having a circumferential groove, a spring adjustably attached at one end to said bracket and disposed in said groove, the other end of said spring attached to said pulley; whereby rotation of said pulley lengthens said coil spring and applies spring bias to said pulley, a fastener on said periphery of said pulley for securing a cantilever arm, said cantilever arm adapted to extend from said fastener normal to said post, and at least one second hose clamp adapted to be adjustably affixed to said cantilever arm whereby said kit may be assembled and support a breathing tubular hose spaced apart from a bed.

2. The support kit according to claim 1 wherein said coupling joint of said post allows said post to be disassembled into at least two pieces.

3. The support kit according to claim 2 wherein said cantilever arm includes an elastic shock cord extending between a first end and a second end, said elastic shock cord allowing said cantilever arm to be folded along a coupling joint for storage.

4. The support kit according to claim 1 wherein said post includes a first section threadedly coupled to second section at said coupling joint, said first section removable from said second section for storage.

5. The support kit according to claim 4 wherein said post is extended by attaching an additional section to said second section at said coupling joint.

6. The support kit according to claim 1 wherein said adjustable coil spring includes a first end secured to a threaded rod, said threaded rod extending through an aperture in said bracket with a threaded locking nut rotatable along the threaded rod providing tension adjustment to said coil spring for applying spring bias to said pulley.

7. The support kit according to claim 5 wherein said threaded rod includes a ring member whereby said ring member can be pulled with finger pressure allowing said coil spring to be stretched wherein said locking nut can be repositioned along the length of the threaded rod to provide a preferred tension.

8. The support kit according to claim 1 wherein said bi-pod fixture includes two cross drilled apertures, said apertures used for storage of said base rod.

9. The support kit according to claim 1 wherein each said support leg includes an elastic shock cord extending between a first end and a second end, said elastic shock cord allowing said support leg to be folded along a coupling joint for storage.

10. A support kit for a breathing hose comprising a base for contacting a bed, a hollow post having a top end, a bottom end with a coupling joint therebetween allowing said post to be separated at said coupling joint; said bottom end of said post adapted to be removably attached to said base normal to said bed, a first pair of hose clamps slidably affixed to said post adapted to engage a breathing hose, a bracket adapted to be connected to said top end of said post, said bracket including a pulley mounted to rotate in a plane parallel with said post, a spring having a first end secured to a threaded rod, said threaded rod extending through an aperture in said bracket with a threaded locking nut rotatable along the threaded rod providing tension adjustment to said coil spring and to said pulley biasing the rotation of said pulley, a fastener on said periphery of said pulley for securing a cantilever arm, said cantilever arm adapted to extend from said fastener normal to said post, and a second pair of hose clamps adapted to be adjustably affixed to said cantilever arm whereby said kit may be assembled and support a breathing hose spaced apart from a bed, said bracket having spaced apart opposed sides, an axle connecting said sides, said pulley rotating about said axle, a connector disposed between said opposed sides for receiving said top end of said post, and a fastener attached to said connector for securing said post in said connector, a coil spring having one end attached to a threaded rod and the other end attached to said pulley, said pulley having a circumference, said coil spring disposed about said circumference whereby rotation of said pulley lengthens said coil spring and applies spring bias to said pulley, a spring stop mounted on said pulley and extending outwardly therefrom, said spring stop engaging an opposed side of said bracket when said spring is unbiased.

11. The support kit for a breathing hose of claim 10 comprising said post having a plurality of sections, said sections being connected telescopically to each other.

12. The support kit according to claim 10 wherein said threaded rod includes a ring member whereby said ring member can be pulled with finger pressure allowing said coil spring to be stretched wherein said locking nut can be repositioned along the length of the threaded rod to provide a preferred tension.

13. The support kit according to claim 10 wherein said base fixture includes cross drilled holes, each said hole used for storage of a base rod when one-piece rods are employed.

14. The support kit according to claim 10 wherein said threaded rod includes a ring member whereby said ring member can be pulled with finger pressure allowing said coil spring to be stretched wherein said locking nut can be repositioned along the length of the threaded rod to provide a preferred tension.

15. The support kit according to claim 10 wherein said cantilever arm includes an elastic shock cord extending between a first end and a second end, said elastic shock cord allowing said cantilever arm to be folded along a coupling joint for storage.

16. The support kit according to claim 10 wherein each said support leg includes an elastic shock cord extending between a first end and a second end, said elastic shock cord allowing said support leg to be folded along a coupling joint for storage.
